(19) United States
(12) Patent Application Publication
(10) Pub. No.: US 2008/0285505 A1
(43) Pub. Date: Nov. 20, 2008

(54) SYSTEM AND METHOD FOR NETWORK TIMING RECOVERY IN COMMUNICATIONS NETWORKS

(75) Inventors: John Carlson, Dulles, VA (US); Roger Alexander, Rockville, MD (US); Selcuk Mazlum, Frederick, MD (US)

Correspondence Address: Duane Morris LLP, 505 9th Street, N.W., Suite 1000, Washington, DC, 20004, US

(73) Assignee: ANDREW CORPORATION, Westchester, IL (US)

(21) Appl. No.: 11/749,101

(22) Filed: May 15, 2007

(51) Int. Cl. H04Q 7/00

(52) U.S. Cl. 370/328

(57) ABSTRACT

A system and method for determining the network timing of a communications network from a mobile station that receives signals from a plurality of base stations. An estimated location of a mobile station may be determined through any number of or combination of location technologies. Network measurements such as observed time difference values and/or a round trip time values at the mobile station or base stations in the network may be utilized. Network timing relationships may be determined as a function of the estimated location and network measurements. An estimated location of a second mobile station may be determined as a function of the network timing relationships.

### RELATED APPLICATIONS

The instant application is co-pending and related to U.S. application Ser. No. ______, filed _, entitled “System and Method for Estimating the Location of a Mobile Station in Communications Networks,” the entirety of which is incorporated herein by reference.

### BACKGROUND

A number of applications currently exist within communication systems, such as those supporting Global System for Mobile Communication (“GSM”), Time Division Multiple Access (“TDMA”), Code Division Multiple Access (“CDMA”) and Universal Mobile Telecommunications System (“UMTS”) technologies, for which precise common timing information is needed by mobile units and by other entities in a wireless network. Examples of such applications include GSM positioning and assisted global positioning system (“A-GPS”) positioning. Mobile units with A-GPS acquire and measure signals from a number of GPS satellites in order to obtain an accurate estimate of their current geographic position. It is well known that precise knowledge of GPS time can greatly improve positioning measurements for higher sensitivity in otherwise poor signal areas, e.g., indoors or urban areas where a GPS satellite signal may be blocked. Another application would be accurate time stamping of significant events (e.g. alarms and faults) by network entities such that events emanating from the same cause but registered in different entities could more easily be associated through their common time of occurrence.

In some wireless technologies, e.g., CDMA, the transmission timing of all base stations has to be precisely and explicitly synchronized to a common time source, such as a Global Positioning System (“GPS”) originated clock. Such a precise transmission timing clock provides wireless terminals with unrestricted access to precise common timing information without any special additional support. In other technologies, like GSM and TDMA, each base station maintains its own local timing source, which, though precise within its own frame of reference, does not indicate a particular universal time nor align with the timing maintained by other base stations.

Providing precise common timing information for GSM, TDMA or UMTS base stations may require deploying additional units such as Location Measurement Units (“LMU”) that measure and associate the transmission timing of one or more base stations with a common timing source. Generally, an LMU is a device that measures the downlink timing of each base station, relative to a stable time base such as GPS, either through a direct RF connection in the base station, or through an over the-air, antenna based connection. The precise association of the local timing of each base station with the common timing source may be passed to mobile units and base stations for deriving accurate timing, according to the common timing source, from the local transmission timing of a particular base station, e.g., the base station serving a particular mobile unit. GSM LMUs tend to require additional hardware and are expensive additions in any wireless network. Moreover, in order to synchronize the transmission timing of every wireless network base station with a common timing source, it may be necessary to deploy a separate measurement unit for every base station, or every few base stations, thereby further increasing cost and deployment time.

There exists a need in the art to locate UMTS or W-CDMA mobile devices to satisfy FCC E-911 regulations as well as to provide Location Based Services for mobile phone users. The 3GPP UMTS standard outlines several methods for location including Cell-ID, A-GPS, Observed Time Difference of Arrival (“OTDOA”), and Uplink Time Difference of Arrival (“U-TDOA”). Cell-ID generally is the simplest method which provides coarse positioning of mobile devices based on a known location of the coverage area centroid of each base station sector. Additionally, A-GPS is a straightforward implementation for network and handset manufacturers due to their legacy in CDMA2000 networks. Likewise, U-TDOA is also a straightforward technique for those skilled in the art and has been widely deployed for other air standards. OTDOA, on the other hand, is confronted with significant implementation challenges for carriers, due to the fact that the base station timing relationships must be known, or measured, for this technique to be viable. For unsynchronized UMTS networks, where the base station timing is not locked to a common timing source, the 3GPP standard offers the suggestion that base station LMUs may be utilized to recover this timing information. Once the base station timing relationships are measured, the handset measurements of Observed Time Difference (“OTD”) between various base stations may be translated into absolute range differences from which position can be calculated (e.g., through user equipment (“UE”)-based or UE-assisted methods).

There appears to be little interest by network operators in implementing the OTDOA solution. This may be due to a general lack of cost-effective solutions for practical implementations of OTDOA in unsynchronized UMTS networks, significant hardware, installation, testing, and maintenance costs associated with LMUs, and/or a lack of available LMU vendors. Further, the lack of interest by network operators in implementing the OTDOA solution may also be due to a lack of handset manufacturers implementing OTDOA measurements into the associated firmware, negative perception of OTDOA due to the potential network capacity impacts if Idle Period Downlink (“IPDL”) is enabled by carriers, and/or carrier perception that A-GPS handsets will meet all the location needs of its users.

Accordingly, there is a need for a method and system for location and network timing recovery in communications networks. Therefore, an embodiment of the present subject matter provides a method for determining the network timing of a communications network from a mobile station that receives signals from a plurality of base stations. The method comprises the steps of determining an estimated location of a mobile station and utilizing a first set of network measurements such as OTD values at the mobile station between a first signal received from a first base station and a second signal received from a second base station. A second set of network measurements such as round trip time (“RTT”) values may be utilized at the mobile station or base stations in the network and a network timing value may be determined as a function of the estimated location and OTD and RTT values. An alternative embodiment of the present subject matter may update the network timing value as a function of a base station time offset drift value for a base station time offset between the first and second base stations.

An additional embodiment of the present subject matter may provide a system for determining the network timing of a communications network from a mobile station that receives signals from a plurality of base stations. The system may comprise circuitry for determining an estimated location of a mobile station and circuitry for utilizing a first set of network measurements such as OTD values at the mobile station between a first signal received from a first base station and a second signal received from a second base station. The system may further comprise circuitry for utilizing a second set of network measurements such as RTT values at the mobile station or base stations in the network and circuitry for determining a network timing value as a function of the estimated location and the OTD and RTT values. An additional embodiment of the present subject matter may comprise circuitry for updating the network timing value as a function of a base station time offset drift value for a base station time offset between the first and second base stations. An alternative embodiment of the present subject matter may comprise circuitry for transmitting the estimated location and network measurements to the communications network where the network determines the network timing values. Additional embodiments of the present subject matter may also comprise circuitry for transmitting the estimated location and network measurements to a system remote from the communications network where the system remote determines the network timing values.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

FIG. 1 is an illustration of a wireless communications network.

FIG. 2 is an algorithm according to one embodiment of the present subject matter.

FIG. 3 is an algorithm according to a further embodiment of the present subject matter.

FIG. 4 is an algorithm according to another embodiment of the present subject matter.

### DETAILED DESCRIPTION

With reference to the figures where like elements have been given like numerical designations to facilitate an understanding of the present subject matter, the various embodiments of a system and method for location and network timing recovery in communications networks are described.

Embodiments of the present subject matter overcome the challenges associated with implementing non Assisted Global Positioning System (“A-GPS”) based location methods in unsynchronized Universal Mobile Telecommunications System (“UMTS”) networks. Embodiments of the present subject matter also derive and maintain base station timing relationships from a mobile device, station or handset measured Observed Time Differences (“OTD”). The terms “device”, “handset” and “station” are utilized interchangeably through the present disclosure and such use is not intended to limit the scope of the claims appended herewith. Handset OTDs may be derived through periodic measurement reporting needed to support on-going radio link communications as well as through explicit, event-driven measurement reporting requested by the network. For mobile unit location determination, however, handset OTDs are meaningless without knowledge of underlying base station timing relationships.

Embodiments of the present subject matter also provide alternate methods to derive base station timing information. Thus, once the base station timing relationships are known, the positions of either the same mobile device or other mobile devices may be calculated completely, or partly, from the OTDs at a later time. This aspect of the present subject matter provides that location capability may be available to non-A-GPS handsets in a network and that high volume mobile device location may be easily computed through existing network handset measurements without consuming the time, battery, and/or network capacity associated with A-GPS position estimation. The latter is a sought after requirement for enhanced network optimization utilizing geo-coded measurements, as well as for security applications requiring frequent position updates for all active users in a network. Another aspect of the present subject matter provides an accurate fallback location method when other methods, such as A-GPS, fail. It is anticipated that A-GPS yield will be poor in areas where open-sky conditions do not exist, e.g., indoors and urban environments. While A-GPS is designed to improve yield in such conditions, many scenarios exist in where A-GPS may not provide enough gain over conventional GPS to produce a successful A-GPS fix. Furthermore, base station time relationships tend to drift over time as a function of oscillator characteristics utilized in the respective base stations. This drift must also be accounted for when utilizing these methods, either through periodic updating of the estimated base station time relationships (base station timing offsets or “BSTO”) or through known means to track and predict timing relationships via prediction methods based on past measurement timing trends. Exemplary means of prediction are well-known in the industry and are a manageable problem to those skilled in the art, and will thus not be the subject of further discussion herein.

OTDs generally define a set of handset based measurements known in the 3GPP standard such as System Frame Number “SFN-SFN” Type 1 and/or Type 2. These measurements are generally the observed time difference of two base station cells or sectors and differ primarily in the timing resolution of the measurements. For example, with Type 1, a mobile device measures the timing difference between the Primary Common Control Physical Channels (“P-CCPCH”) of cell 1 and cell 2. Type 1 is generally available on a CELL_FACH connection. While a soft handover cannot be performed while on a CELL_FACH connection, the network may request the mobile device to measure the timing difference between cell 1 and cell 2. While on a CELL_FACH connection, a Measurement Control Message may be sent to the mobile device on the Forward Access Channel (“FACH”), and the mobile device's measurement results are returned on the Reverse Access Channel (“RACH”). With Type 2, the mobile device measures the timing difference between the Common Pilot Channels (“CPICH”) of cell 1 and cell 2. Type 2 is applicable to both CELL_DCH and CELL_FACH connections. With either connection type, if there is power in cell 2, the mobile may measure the timing difference between the two cells. While on a CELL_DCH connection, the mobile device may measure OTDs while in soft handover with cells 1 and 2. Another set of handset based measurements known in the 3GPP standard is SFN-Connection Frame Number (“CFN”). These measurements refer to the observed time difference between the connection to a current serving base station cell and some set of handset-measurable, neighboring cells or sectors.

Providing that a given network employs A-GPS capability and that some number of A-GPS capable mobile devices exist in the network, embodiments of the present subject matter may pair A-GPS derived handset locations and the coincidental OTD measurements made against various nearby base stations. Once the handset location is known, the base station timing relationships may be directly derived from the OTDs. Further embodiments may utilize other standardized network measurements. For example, Round Trip Time (“RTT”) is a standardized network measurement that may be determined from one or more base stations in communication with a particular mobile device. If the mobile device is in soft handoff with at least three base stations, a position may be determined for that mobile device from the various RTTs. Given that the handset OTDs may be concurrently measured, this provides an opportunity to compute the base station time relationships given that the mobile location is now known. Thus, mobile location with a single ambiguity may be calculated with as few as two RTTs. Furthermore, such an embodiment may be improved if one of the ambiguous locations may be eliminated based upon other available information such as sector orientations and received power levels from those sectors.

In networks employing an Uplink Time Difference of Arrival (“U-TDOA”) location system, base station timing relationships may be derived from the concurrently measured handset OTDs from positions calculated by the U-TDOA system. An alternative method to derive base station timing relationships may be to deploy some number of mobiles into known locations throughout the network, where the positions thereof are unchanging and known. Provided that these mobiles are placed in positions allowing them to observe multiple OTDs, these mobiles may be utilized by the network to determine the base station timing relationships since the position from which the measurements were taken is known.

Additional embodiments of the present subject matter may determine base station timing relationships by deploying some number of cooperative mobile devices or other measurement devices in either stationary or mobile environments. These devices may be equipped with GPS positioning or some other accurate location means, make OTD measurements, and provide these measurements to the network in conjunction with their known positions to thereby allow the network to derive the applicable base station timing relationships. An exemplary device may be, but is not limited to, a UMTS mobile connected to a GPS receiver, where the coordinates of the GPS position may be periodically relayed to the network along with the OTDs. Deployment of such devices may occur upon buses, taxis, or other vehicles or in stationary locations. Further methods to determine location of mobile devices by embodiments of the present subject matter may be through various pattern matching methods that pair sets of measurements observed by a mobile device in the network to geographical position. Exemplary handset observed measurements may be, but are not limited to, a set of received signal strengths, transmit power, calculated path losses, active, detected, and monitored pilot sets, multi-path propagation profiles, and the like. Once a mobile device's location is determined through pattern matching of measurements to location, concurrent OTDs measured by the mobile device may be utilized to determine the base station timing relationships. Other embodiments of the present subject matter may utilize hybrid methods to recover base station timing relationships, e.g., pattern matching may be combined with RTT and/or cooperative mobile devices, etc. Thus, as long as there are sufficient measurements from which locations could be computed, concurrently measured OTDs may be utilized to derive the base station timing relationships. Further, any of the aforementioned embodiments in conjunction with the deployment of some number of network Location Measurement Units (“LMU”) may provide mobile location estimates, and hence derive the base station timing relationships from the handset OTDs. It is thus an aspect of the present subject matter that any location means or technology, when paired with handset OTDs, may be utilized to derive and maintain on an on-going basis network base station timing relationships.

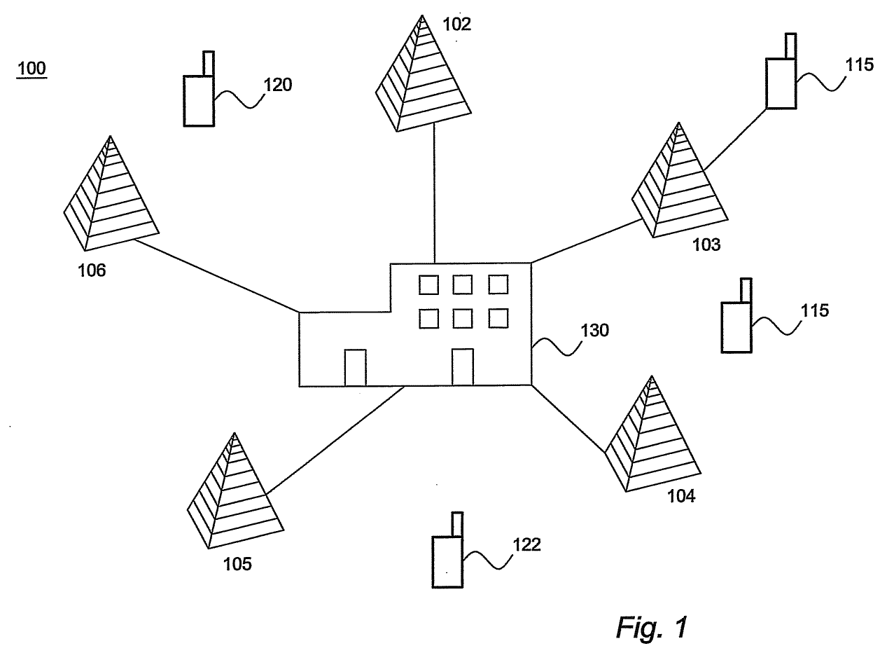

FIG. 1 is an illustration of a wireless communications network. With reference to FIG. 1, a wireless communications network 100 or system is shown. The network may be a Global System for Mobile Communication (“GSM”) network, a Time Division Multiple Access (“TDMA”) network, Code Division Multiple Access (“CDMA”) network, a UMTS network, a Worldwide Interoperability for Microwave Access (“WiMax”) network, a WiFi network, networks utilizing Evolution-Data Optimized (“EDVO”), CDMA2000 network, 1 times Radio Transmission Technology (“1xRTT”) standards or another equivalent network.

Location measurement units (“LMU”) 115 may be dispersed throughout the system or subsystem reception area. These LMUs 115 may be integrated with a base station 102-106 or may be independent of a base station 102-106. The wireless network 100 serves mobile stations or devices 120, 122 within reception range of at least one of the base stations 102-106. Mobile stations 120, 122 may include cellular telephones, text messaging devices, computers, portable computers, vehicle locating devices, vehicle security devices, communication devices, wireless transceivers or other devices with a wireless communications interface. Base station transceivers 102-106, also commonly referred to simply as base stations, are connected to a central entity or central network unit 130. The central entity 130 may be a base station controller (“BSC”) in a base station subsystem (“BSS”), a Radio Network Controller (“RNC”) in a Radio Access Network (“RAN”), or, for GSM, General Packet Radio Service (“GPRS”) or UMTS system, a serving mobile location center (“SMLC”) or an equivalent. The connection from each base station to a BSC, SMLC or other central network entity may employ a direct transmission link, e.g., a wired connection, microwave link, Ethernet connection, and the like, or may be employed by one or more intermediate entities, e.g., an intermediate BSC in the case of a connection from a BTS to an SMLC for GSM.

Each mobile station 120, 122 may periodically measure the transmission timing difference between pairs of base stations 102-106. For example, a mobile station 120 may measure the difference in transmission timing for communication from its serving base station 102 and from one or more neighboring base stations, e.g., 106 and/or 103. Either the mobile station or the base station may remove differences attributed primarily to propagation delays between the mobile station and base station antennas to produce a timing difference.

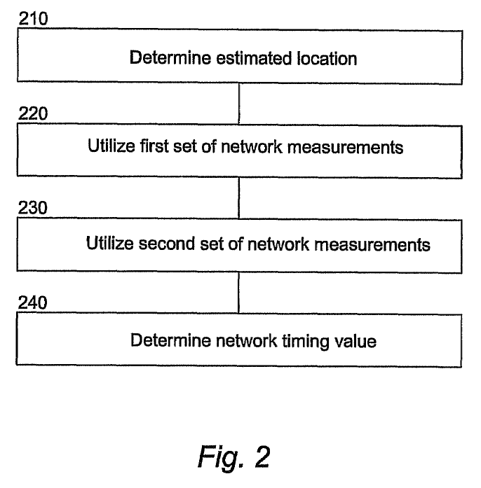

FIG. 2 is an algorithm according to one embodiment of the present subject matter. With reference to FIG. 2, a method for determining the network timing of a communications network from a mobile station receiving signals from a plurality of base stations is provided. Exemplary communications networks may be a UMTS network, WiMax network, GSM network, WiFi network, CDMA network or a network utilizing EDVO, CDMA2000, 1xRTT standards. However, the aforementioned examples are not intended to limit the scope of the claims appended herewith. In step 210, an estimated location of a mobile station or device may be determined. An exemplary mobile station may be, but is not limited to a cellular telephone, text messaging device, computer, portable computer, vehicle locating device, vehicle security device, communication device, and wireless transceiver. The estimated location may be determined as a function of an OTDOA, RTT, signal strength and/or Cell-ID values. Appropriate values may be observed by the mobile device and/or the network. Additionally, the estimated location may be determined as a function of signals received from a positional satellite system such as GPS or may be determined as a function of signals received from one or more LMUs installed throughout the network. These LMUs may be co-located at a base station or may be provided locations separate from a base station. In alternative embodiments the mobile station may be a cooperative mobile station or other measurement device positioned at a known geographic location. Additional embodiments may determine mobile device location as a function of a location system that locates mobile devices through a hybrid combination of location technologies such as triangulation, trilateration, time difference of arrival, GPS, angle of arrival, Cell-ID, signal strength, assisted-GPS, Enhanced Observed Time Difference, Advanced Forward Linlc Trilateration.

A first set of network measurements such as OTD values may be utilized at the mobile station between a first signal received from a first base station and a second signal received from a second base station as represented in step 220. As previously described, these OTD values may be SFN-SFN Type 1, SFN-SFN Type 2, or SFN-CFN and may be determined periodically or by a request transmitted from said communication network. Furthermore, the first and second base stations may or may not be synchronized. Additionally the first and second base stations are loosely synchronized, i.e., synchronization between the base stations is not maintained to within approximately one hundred nanoseconds or less. The first base station may be, but is not limited to, the serving base station for the mobile. Further, the first and second base stations may be located in different or the same sectors or cells.

A second set of network measurements such as RTT values may be utilized at the mobile station or base stations in the network in step 230. Network timing relationships may then be determined as a function of the estimated location and the OTD and RTT values in step 240. An alternative embodiment of the present subject matter may also update the network timing value as a function of a base station time offset drift value for a base station time offset between the first and second base stations. The estimated location and network measurements may also be transmitted to the communications network or to a system remote from the communications network where the network determines the network timing values in additional embodiments of the present subject matter.

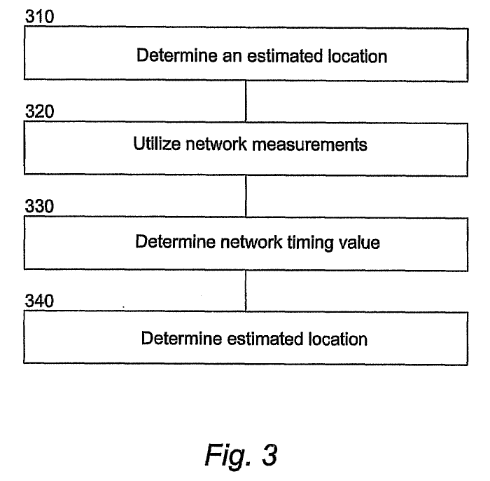

FIG. 3 is an algorithm according to a further embodiment of the present subject matter. With reference to FIG. 3, a method for estimating the location of a mobile station that receives signals from a plurality of base stations is provided. The base stations may be operable in a communications network such as, but not limited to, a UMTS network, WiMax network, GSM network, WiFi network, CDMA network or a network utilizing EDVO, CDMA2000, or 1xRTT standards. In step 310, an estimated location of a first mobile station is determined. An exemplary mobile station may be, but is not limited to a cellular telephone, text messaging device, computer, portable computer, vehicle locating device, vehicle security device, communication device, and wireless transceiver. The estimated location may be determined as a function of an OTDOA, RTT, signal strength and/or Cell-ID values. Appropriate values may be observed by the mobile device and/or the network. Additionally, the estimated location may be determined as a function of signals received from a positional satellite system such as GPS or may be determined as a function of signals received from one or more LMUs installed throughout the network. These LMUs may be co-located at a base station or may be provided locations separate from a base station. In alternative embodiments the mobile station may be a cooperative mobile station or other measurement device positioned at a known geographic location. Additional embodiments may determine mobile device location as a function of a location system that locates mobile devices through a hybrid combination of location technologies such as triangulation, trilateration, time difference of arrival, GPS, angle of arrival, Cell-ID, signal strength, assisted-GPS, Enhanced Observed Time Difference, Advanced Forward Link Trilateration.

Network measurements such as OTD values may be utilized at the first mobile station between a first signal received from a first base station and a second signal received from a second base station as represented in step 320. As previously described, these OTD values may be SFN-SFN Type 1, SFN-SFN Type 2, or SFN-CFN and may be determined periodically or by a request transmitted from said communication network. Furthermore, the first and second base stations may or may not be synchronized. Additionally the first and second base stations are loosely synchronized. The first base station may be, but is not limited to, the serving base station for the mobile. Further, the first and second base stations may be located in different or the same sectors or cells.

Network timing relationships may be determined as a function of the estimated location and the OTD in step 330. In step 340, an estimated location of a second mobile station may then be determined as a function of the network timing relationships. An alternative embodiment of the present subject matter may also update network timing relationships as a function of a base station time offset drift value for a base station time offset between the first and second base stations. The estimated location and network measurements may also be transmitted to the communications network or to a system remote from the communications network where the network determines the network timing values in additional embodiments of the present subject matter.

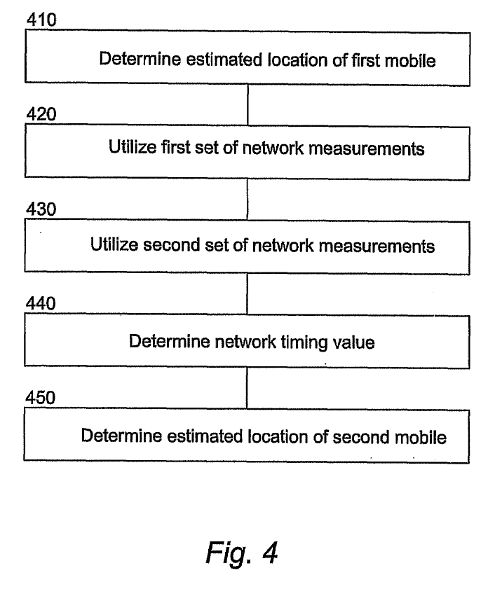

FIG. 4 is an algorithm according to another embodiment of the present subject matter. With reference to FIG. 4, a method for estimating the location of a mobile station that receives signals from a plurality of base stations is provided. The base stations may be operable in a communications network such as, but not limited to, a UMTS network, WiMax network, GSM network, WiFi network, CDMA network or a network utilizing EDVO, CDNA2000, or 1xRTT standards. In step 410, an estimated location of a first mobile station is determined. An exemplary mobile station may be, but is not limited to a cellular telephone, text messaging device, computer, portable computer, vehicle locating device, vehicle security device, communication device, and wireless transceiver. The estimated location may be determined as a function of an OTDOA, RTT, signal strength and/or Cell-ID values. Appropriate values may be observed by the mobile device and/or the network. Additionally, the estimated location may be determined as a function of signals received from a positional satellite system such as GPS or may be determined as a function of signals received from one or more LMUs installed throughout the network. These LMUs may be co-located at a base station or may be provided locations separate from a base station. In alternative embodiments the mobile station may be a cooperative mobile station or other measurement device positioned at a known geographic location. Additional embodiments may determine mobile device location as a function of a location system that locates mobile devices through a hybrid combination of location technologies such as triangulation, trilateration, triangulation, time difference of arrival, GPS, angle of arrival, Cell-ID, signal strength, assisted-GPS, Enhanced Observed Time Difference, Advanced Forward Link Trilateration.

A first set of network measurements such as OTD values may be utilized at the first mobile station between a first signal received from a first base station and a second signal received from a second base station as represented in step 420. As previously described, these OTD values may be SFN-SFN Type 1, SFN-SFN Type 2, or SFN-CFN and may be determined periodically or by a request transmitted from said communication network. Furthermore, the first and second base stations may or may not be synchronized. Additionally the first and second base stations are loosely synchronized. The first base station may be, but is not limited to, the serving base station for the mobile. Further, the first and second base stations may be located in different or the same sectors or cells. A second set of network measurements such as RTT values may be utilized at the first mobile station or base stations in the network in step 430. Network timing relationships may then be determined as a function of the estimated location and the first and second set of network measurements as represented in step 440.

In step 450, an estimated location of a second mobile station may then be determined as a function of the network timing relationships. An alternative embodiment of the present subject matter may also update network timing relationships as a function of a base station time offset drift value for a base station time offset between the first and second base stations. The estimated location and network measurements may also be transmitted to the communications network or to a system remote from the communications network where the network determines the network timing values in additional embodiments of the present subject matter.

As shown by the various configurations and embodiments illustrated in FIGS. 1-4, a system and method for location and network timing recovery in communications networks have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What we claim is:

1. A method for determining the network timing of a communications network from a mobile station that receives signals from a plurality of base stations, comprising:
(a) determining an estimated location of a mobile station;
(b) utilizing a first set of network measurements such as observed time difference (“OTD”) values at said mobile station between a first signal received from a first base station and a second signal received from a second base station;
(c) utilizing a second set of network measurements such as round trip time (“RTT”) values at said mobile station or base stations in the network; and
(d) determining a network timing value as a function of said estimated location and said OTD and RTT values.

2. The method of claim 1 wherein said first and second base stations are not synchronized.

3. The method of claim 1 wherein said first and second base stations are loosely synchronized.

4. The method of claim 1 wherein said first base station is a serving base station.

5. The method of claim 1 wherein said first base station and said second base station are located in different sectors.

6. The method of claim 1 wherein said first base station and said second base station are located in the same sector.

7. The method of claim 1 wherein said OTD is selected from the group consisting of: System Frame Number (“SFN”)-SFN Type 1, SFN-SFN Type 2, SFN-Connection Frame Number (“CFN”).

8. The method of claim 1 wherein said OTDs are determined periodically.

9. The method of claim 1 wherein said OTDs are determined by a request transmitted from said communication network.

10. The method of claim 1 further comprising the step of updating said network timing value as a function of a base station time offset drift value for a base station time offset between said first and second base stations.

11. The method of claim 1 wherein said mobile station is selected from the group consisting of: cellular telephone, text messaging device, computer, portable computer, vehicle locating device, vehicle security device, communication device, and wireless transceiver.

12. The method of claim 1 wherein said estimated location is determined as a function of an observed time difference of arrival (“OTDOA”) value.

13. The method of claim 1 wherein said estimated location is determined as a function of a round trip time (“RTT”) value.

14. The method of claim 1 wherein said estimated location is determined as a function of a Cell-ID value.

15. The method of claim 1 wherein said estimated location is determined as a function of signals received from a positional satellite system.

16. The method of claim 15 wherein said positional satellite system is Global Positioning System (“GPS”).

17. The method of claim 1 wherein said estimated location is determined as a function of signals received from one or more location measurement units (“LMU”) installed throughout the network.

18. The method of claim 17 wherein said LMU is co-located at a base station.

19. The method of claim 17 wherein said LMU is provided at a location separate from a base station.

20. The method of claim 1 wherein said mobile station is a cooperative mobile station positioned at a known geographic location.

21. The method of claim 1 wherein said mobile station is a measurement device positioned at a known geographic location.

22. The method of claim 20 wherein said cooperative mobile station is adaptable to receive signals received from a positional satellite system.

23. The method of claim 21 wherein said measurement device is adaptable to receive signals from a positional satellite system.

24. The method of claim 1 wherein said estimated location is determined as a function of a location system that locates mobile devices through measurement of signal strengths.

25. The method of claim 24 wherein said signal strength is observed by said mobile device.

26. The method of claim 24 wherein said signal strength is observed by said network.

27. The method of claim 1 wherein said estimated location is determined as a function of a location system that locates mobile devices through a hybrid combination of location technologies.

28. The method of claim 27 wherein said location technologies are selected from the group consisting of: triangulation, trilateration, time difference of arrival, GPS, angle of arrival, Cell-ID, signal strength, assisted-GPS, Enhanced Observed Time Difference, Advanced Forward Link Trilateration.

29. The method of claim 1 wherein said estimated location is determined as a function of any positioning system.

30. The method of claim 22 further comprising the step of transmitting said estimated location and said network measurements to said communications network, wherein said network determines said network timing values.

31. The method of claim 22 further comprising the step of transmitting said estimated location and said network measurements to a system remote from said communications network, said system determining said network timing values.

32. The method of claim 1 wherein said communications network is selected from the group consisting of: Universal Mobile Telecommunications System (“UMTS”) network, Worldwide Interoperability for Microwave Access (“WiMax”) network, Global System for Mobile Communications (“GSM”) network, WiFi network, Code Division Multiple Access (“CDMA”) network.

33. The method of claim 1 wherein said communications network operates under a standard selected from the group consisting of: IS-95, Evolution-Data Optimized (“EDVO”), CDMA2000, and 1 times Radio Transmission Technology (“1xRTT”).

34. A system for determining the network timing of a communications network from a mobile station that receives signals from a plurality of base stations, comprising:
(a) circuitry for determining an estimated location of a mobile station;
(b) circuitry for utilizing a first set of network measurements such as observed time difference (“OTD”) values at said mobile station between a first signal received from a first base station and a second signal received from a second base station;
(c) circuitry for utilizing a second set of network measurements such as round trip time (“RTT”) values at said mobile station or base stations in the network; and
(d) circuitry for determining a network timing value as a function of said estimated location and said OTD and RTT values.

35. The system of claim 34 wherein said first and second base stations are not synchronized.

36. The system of claim 34 wherein said first and second base stations are loosely synchronized.

37. The system of claim 34 wherein said first base station is a serving base station.

38. The system of claim 34 wherein said first base station and said second base station are located in different sectors.

39. The system of claim 34 wherein said first base station and said second base station are located in the same sector.

40. The system of claim 34 wherein said OTD is selected from the group consisting of: System Frame Number (“SFN”)-SFN Type 1, SFN-SFN Type 2, SFN-Connection Frame Number (“CFN”).

41. The system of claim 34 wherein said OTDs are determined periodically.

42. The system of claim 34 wherein said OTDs are determined by a request transmitted from said communication network.

43. The system of claim 34 further comprising circuitry for updating said network timing value as a function of a base station time offset drift value for a base station time offset between said first and second base stations.

44. The system of claim 34 wherein said mobile station is selected from the group consisting of: cellular telephone, text messaging device, computer, portable computer, vehicle locating device, vehicle security device, communication device, and wireless transceiver.

45. The system of claim 34 wherein said estimated location is determined as a function of an observed time difference of arrival (“OTDOA”) value.

46. The system of claim 34 wherein said estimated location is determined as a function of a round trip time (“RTT”) value.

47. The system of claim 34 wherein said estimated location is determined as a function of a Cell-ID value.

48. The system of claim 34 wherein said estimated location is determined as a function of signals received from a positional satellite system.

49. The system of claim 48 wherein said positional satellite system is Global Positioning System (“GPS”).

50. The system of claim 34 wherein said estimated location is determined as a function of signals received from one or more location measurement units (“LMU”) installed throughout the network.

51. The system of claim 50 wherein said LMU is co-located at a base station.

52. The system of claim 50 wherein said LMU is provided at a location separate from a base station.

53. The system of claim 34 wherein said mobile station is a cooperative mobile station positioned at a known geographic location.

54. The system of claim 34 wherein said mobile station is a measurement device positioned at a known geographic location.

55. The system of claim 53 wherein said cooperative mobile station is adaptable to receive signals received from a positional satellite system.

56. The system of claim 54 wherein said measurement device is adaptable to receive signals from a positional satellite system.

57. The system of claim 34 wherein said estimated location is determined as a function of a location system that locates mobile devices through measurement of signal strengths.

58. The system of claim 57 wherein said signal strength is observed by said mobile device.

59. The system of claim 57 wherein said signal strength is observed by said network.

60. The system of claim 34 wherein said estimated location is determined as a function of a location system that locates mobile devices through a hybrid combination of location technologies.

61. The system of claim 60 wherein said location technologies are selected from the group consisting of: triangulation, trilateration, time difference of arrival, GPS, angle of arrival, Cell-ID, signal strength, assisted-GPS, Enhanced Observed Time Difference, Advanced Forward Link Trilateration.

62. The system of claim 34 wherein said estimated location is determined as a function of any positioning system.

63. The system of claim 55 further comprising circuitry for transmitting said estimated location and said network measurements to said communications network, wherein said network determines said network timing values.

64. The system of claim 55 further comprising circuitry for transmitting said estimated location and said network measurements to a system remote from said communications network, said system determining said network timing values.

65. The system of claim 34 wherein said communications network is selected from the group consisting of: Universal Mobile Telecommunications System (“UMTS”) network, Worldwide Interoperability for Microwave Access (“WiMax”) network, Global System for Mobile Communications (“GSM”) network, WiFi network, Code Division Multiple Access (“CDMA”) network.

66. The system of claim 34 wherein said communications network operates under a standard selected from the group consisting of: IS-95, Evolution-Data Optimized (“EDVO”), CDMA2000, and 1 times Radio Transmission Technology (“1xRTT”).
